(19) United States
(12) Patent Application Publication
(10) Pub. No.: US 2024/0360679 A1
(43) Pub. Date: Oct. 31, 2024

(54) WALL PANEL ASSEMBLY WITH DISPLAYED IMAGE

(71) Applicant: 2840629 Ontario Inc., Woodbridge (CA)

(72) Inventors: Giuseppe Prizzi, Woodbridge (CA); Marcello Venafro, Toronto (CA)

(21) Appl. No.: 18/771,422

(22) Filed: Jul. 12, 2024

Related U.S. Application Data
(63) Continuation of application No. PCT/CA2023/050039, filed on Jan. 13, 2023.
(60) Provisional application No. 63/299,336, filed on Jan. 13, 2022.
(60) Provisional application No. 63/419,621, filed on Oct. 26, 2022.

(51) Int. Cl. E04F 13/08

(52) U.S. Cl. CPC E04F 13/0871; E04F 13/0889

(57) ABSTRACT

A kit for producing a wall panel assembly includes a plurality of image-establishing wall panels, each panel having a respective front surface and a respective panel image on at least a portion of the respective front surface. The respective front surface includes a respective recess for receiving a mounting bracket to be supported by the panel. At least a portion of the respective panel image is defined within the respective recess. Each panel is interconnectable with another panel of the plurality of panels to establish a wall panel assembly which includes a completed image defined by co-operation between the panel images of adjacent panels of the wall panel assembly.

### CROSS-REFERENCE TO RELATED APPLICATIONS

This application is continuation of PCT/CA2023/050039, filed on Jan. 13, 2023, which claims priority to U.S. Provisional Patent Applications No. 63/299,336 filed Jan. 13, 2022, and No. 63/419,621, filed Oct. 26, 2022, the contents of each of which are incorporated by reference herein in their entirety.

### FIELD

The present disclosure relates to a wall panel assembly, and a kit for producing the wall panel assembly.

### BACKGROUND

Wall panel assemblies are becoming increasingly popular for enabling removable mounting of various accessories without causing permanent damage to underlying drywall. It is desirable to configure the outer surface of the panels which constitute such wall panel assemblies for displaying complex images or other kind of artwork.

### SUMMARY

In some aspects of the teaching disclosed herein, a kit for producing a wall panel assembly includes a plurality of image-establishing wall panels, each panel having a respective front surface and a respective panel image on at least a portion of the respective front surface. Each respective front surface includes a respective recess for receiving a mounting bracket to be supported by the panel. At least a portion of the respective panel image is defined within the respective recess. Each panel is interconnectable with another panel of the plurality of panels to establish a wall panel assembly which includes a completed image defined by co-operation between the panel images of adjacent panels of the wall panel assembly.

In some aspects, there is provided a kit for producing a wall panel assembly, wherein the kit comprises:
a plurality of image-establishing wall panels;
wherein:
   each one of the image establishing wall panels, independently, includes a respective front surface that defines a respective panel image such that there is provided plurality of panel images; and
   the image-establishing wall panels are co-operatively configured for connection to establish a wall panel assembly which includes a completed image, that is defined by co-operation between the panel images of the connected image-establishing wall panels, and for which there is an absence of a visually discernible discontinuity from a line of sight extending from a point facing the completed image.

In another aspect, there is provided a kit for producing a wall panel assembly, wherein the kit comprises:
a plurality of image-establishing wall panels;
wherein:
   each one of the image-establishing wall panels, independently, includes a respective front surface that defines a respective panel image, such that there is provided plurality of panel images;
   the image-establishing wall panels are co-operatively configured for connection, to establish a wall panel assembly which includes a completed image that is defined by co-operation between the panel images of the connected image-establishing wall panels; and
   the connection is established at one or more joints, and each one of the one or more joints, independently, is concealed from a line of sight extending from a point, facing the completed image

In another aspect, there is provided akin for producing a wall panel assembly, wherein the kit comprises:
a plurality of image-establishing wall panels;
wherein:
   each one of the image-establishing wall panels, independently, includes a respective front surface;
   the image-establishing wall panels are co-operatively configured for connection, to establish a wall panel assembly which includes a completed image that is defined by co-operation between the connected image-establishing wall panels;
   for each one of the connected image-establishing wall panels, independently, the respective front surface defines a respective panel image that defines a portion of the completed image;
   at least one of the wall panels is a partial object image-defining panel;
   and
   for each one of the at least one partial object-image defining panels, independently, the respective panel image is a visual representation of an incomplete object only.

In another aspect, there is provided a kit for producing a wall panel assembly, wherein the kit comprises:
a plurality of image-establishing wall panels;
wherein:
   each one of the image-establishing wall panels, independently, includes a respective front surface that defines a respective panel image, such that there is provided plurality of panel images;
   the image-establishing wall panels are co-operatively configured for connection, to establish a wall panel assembly which includes a completed image, that is defined by co-operation between the panel images of the connected image-establishing wall panels, and includes an outline extending across at least a pair of adjacent panels;
   and
   for each one of the image-establishing wall panels, independently, a central axis of the respective panel image is offset relative to every central axis of the image-establishing wall panel.

In another aspect, there is provided a kit for producing a wall panel assembly, wherein the kit comprises:
a plurality of image-establishing wall panels;
wherein:
   each one of the image-establishing wall panels, independently, includes a respective front surface that defines a respective panel image, such that there is provided plurality of panel images;
   the image-establishing wall panels are co-operatively configured for connection to establish a wall panel assembly which includes a completed image that is defined by co-operation between the panel images of the connected image-establishing wall panels;
   and
   the connection, to establish a wall panel assembly which includes a completed image, is a connection of the image-establishing wall panels in a single order only

In another aspect, there is provided a kit for producing a wall panel assembly, wherein the kit comprises:
a plurality of image-establishing wall panels;
wherein:
   each one of the image-establishing wall panels, independently, includes a respective front surface that defines a respective panel image, such that there is provided plurality of panel images;
   the image-establishing wall panels are co-operatively configured for connection in a plurality of orders; and
   the plurality of orders includes:
      an image-establishing order for establishing a wall panel assembly which includes a completed image that is defined by co-operation between the panel images of the connected image-establishing wall panels; and
      an ineffective image-establishing order for establishing a wall panel assembly which includes a visual representation of other than the completed image.

In another aspect, there is provided a kit for producing a wall panel assembly, wherein the kit comprises:
a plurality of image-establishing wall panels;
wherein:
   each one of the image-establishing wall panels, independently, includes a respective front surface
   for each one of the image-establishing wall panels, independently:
      the respective front surface defines a panel image that is respective to the image-establishing wall panel, such that there is provided plurality of panel images;
      the respective front surface includes a recess, that is respective to the image-establishing wall panel, for receiving emplacement of a mounting bracket with effect that the mounting bracket becomes vertically supported by the image-establishing wall panel; and
      at least a portion of the respective panel image is defined within a recess;
   and
   the image-establishing wall panels are co-operatively configured for connection, to establish a wall panel assembly which includes a completed image, that is defined by co-operation between the panel images of the connected image-establishing wall panels

In another aspect, there is provided a panel which is configured to define a first panel for coupling to a second panel for establishing an assembled configuration, wherein the first panel is configured for co-operating with the second panel, a wall that defines a wall surface, and a fastener configuration for establishing a fastened panel assembly configuration, wherein, in the fastened panel assembly configuration, the assembled configuration is secured to the wall with the fastener configuration such that the assembled configuration covers at least a portion of a surface of the wall;
wherein:
   the first panel includes a first coupling configuration counterpart;
   the second panel includes:
      a second coupling configuration counterpart;
      a front surface, wherein the front surface includes a planar surface portion that is oriented such that, while the fastened panel assembly configuration is established, an axis, that is normal to the respective planar surface portion, is disposed within five (5) degrees, relative to an axis that is normal to the wall surface;
      a recess extending from the planar surface portion;
      a recess-defining surface, extending from spaced-apart upper and lower edges of the planar surface for defining the recess, and including:
         a retaining surface configuration including a forwardly-disposed retaining surface portion and a rearwardly-disposed retaining surface portion;
         wherein:
         the forwardly-disposed retaining surface portion and the mounting bracket-receiving space are co-operatively configured such that, while a mounting bracket is disposed within the recess such that the mounting bracket is supported by the fastened panel assembly configuration, displacement of the mounting bracket, relative to the second panel, in a forwardly direction that is normal to the wall, is opposed by the forwardly-disposed retaining surface portion;
         and
         the rearwardly-disposed retaining surface portion and the recess are co-operatively configured such that, while a mounting bracket is disposed within the recess such that the mounting bracket is supported by the fastened panel assembly configuration, displacement of the mounting bracket, relative to the second panel, in a rearwardly direction that is normal to the wall, is opposed by the rearwardly-disposed retaining surface portion;
         and
         an upper surface portion, extending from the upper edge to the forwardly-disposed retaining surface portion, and oriented such that an axis, that is normal to the upper surface portion, is disposed, relative to the axis that is normal to the planar surface portion, at an angle that is within a range, wherein the range is from 45 degrees to 135 degrees;
      the first coupling configuration counterpart, of the first panel, is configured for co-operation with the second coupling configuration counterpart, of the second panel, such that, in the assembled configuration, the first coupling configuration counterpart, of the first panel, is coupled to the second coupling configuration counterpart, of the second panel;
      and
      the first panel is configured for co-operation with the second panel such that, while the assembled configuration is established, the first coupling configuration counterpart, of the first panel, extends into the recess, of the second panel, with effect that the upper surface portion, of the second panel, is concealed by a concealing portion of the first coupling configuration counterpart, of the first panel

Other aspects will be apparent from the description and drawings provided herein.

### BRIEF DESCRIPTION OF DRAWINGS

In the figures, which illustrate example embodiments,

FIG. 1 is a cross-sectional view of an embodiment of a wall panel of the present disclosure;

FIG. 2 is a cross-sectional view of a first coupling configuration counterpart of the wall panel of FIG. 1, illustrating emplacement of a fastener relative to a fastener receiving portion;

FIG. 3 is an enlarged view of Detail “A” in FIG. 1;

FIG. 4 is an enlarged view of Detail “B” in FIG. 1;

FIG. 5 is a cross-sectional view illustrating connection of the wall panel of FIG. 1 with a second identical one of such wall panel;

FIG. 6 is a cross-sectional view illustrating connection of another embodiment of a wall panel with a second identical one of such wall panel;

FIG. 7 is a cross-sectional view illustrating connection of the wall panel of FIG. 1 with a second identical one of such wall panel, and also illustrating concealment of a fastener that is coupling one of the wall panels to a wall;

FIGS. 8 to 10 illustrate an embodiment of a method of assembling an embodiment of two identical wall panels of the present disclosure;

FIG. 11 is a cross-sectional view illustrating connection of a terminal wall panel, at one end, to a trim component, and at a second opposite end, to another wall panel;

FIG. 12 is a perspective view of an embodiment of a wall panel assembly, assembled from the wall panels of the present disclosure, connected to a wall

FIG. 13 is an exploded view of the wall panel assembly of FIG. 12;

FIG. 14 is a perspective view of another embodiment of a wall panel assembly;

FIG. 15 is another perspective view of the wall panel assembly of FIG. 14;

FIG. 16 is a front view of the wall panel assembly of FIG. 14;

FIG. 17 is a front view of an exploded view of the wall panel assembly of FIG. 14;

FIG. 18 is an enlarged view of Detail “A” in FIG. 16;

FIG. 19 is an enlarged view of Detail “B” in FIG. 16;

FIG. 20 is a front view of a wall panel assembly, consisting of the walls panels of the wall panel assembly in FIG. 16, but with wall panels organized in an ineffective image-establishing order;

FIG. 21 is an exploded view of the wall panel assembly of FIG. 20;

FIG. 22 is a side elevation view of an embodiment of the wall panel assembly of either one of FIG. 12 or FIG. 14, and additionally illustrating the line of sight; and

FIG. 23 is a front perspective view of an exemplary mounting bracket for mounting to an embodiment of the wall panel assembly of either one of FIG. 12 or FIG. 14.

### DETAILED DESCRIPTION

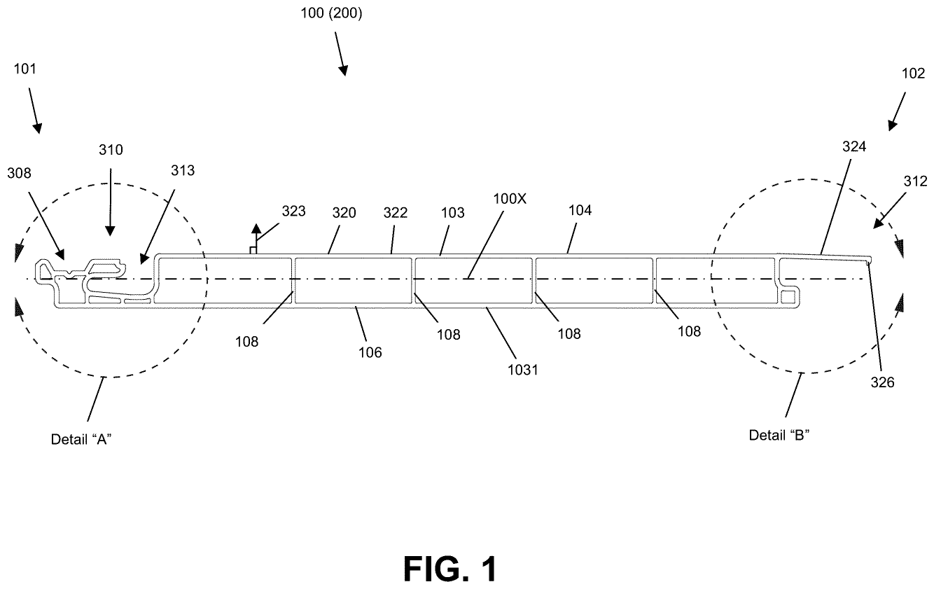

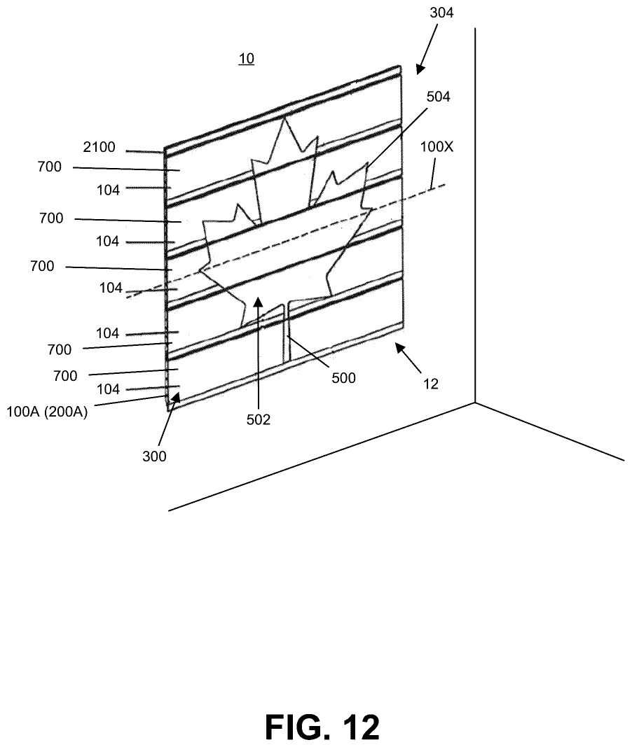

FIGS. 1 and 12 illustrate an embodiment of a panel 100 for covering at least a portion of a surface of a wall 10. The panel 100 is configure for coupling to the wall 10 with a fastener configuration 400, such that the covering of at least a portion of a surface 12 of the wall 10 is effectuated.

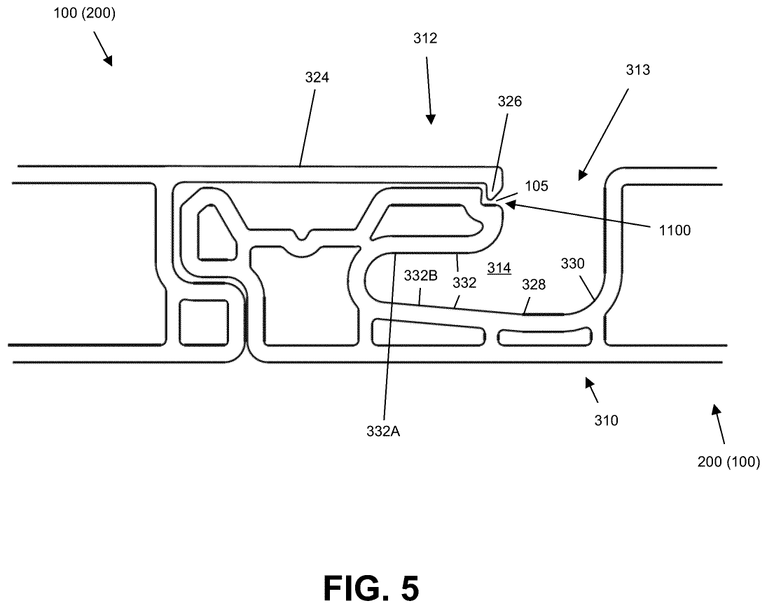

In some embodiments, for example, the panel 100 is configured to define a first panel 100 for coupling to a second panel 200, such that an assembled configuration 300 is established (see FIGS. 5, 6, and 12). In some embodiments, for example, in the assembled configuration 300, the first panel 100 is disposed adjacent to the second panel 200. The first panel 100 is configured for co-operating with the second panel 200, a wall 10, and a fastener configuration 400 for establishing a fastened panel assembly configuration 304 (see FIG. 12). In the fastened panel assembly configuration 304, the assembled configuration 300 is secured to the wall 10 with the fastener configuration 400 such that the assembled configuration 300 covers at least a portion of a surface 12 of the wall 10. In some embodiments, for example, the first panel 100 is identical to the second panel 200. In some embodiments, for example, the first panel 100 is different that the second panel 200.

In some embodiments, for example, the first and second panels 100, 200 are included within a plurality of panels (such that the plurality of panels include the first and second panel 100, 200), and the plurality of panels are connectible in series for establishing a second assembled configuration. In some embodiments, for example, the series is a vertically-oriented series. In some embodiments, for example, in the second assembled configuration, with the exception of the terminal panels of the series of panels, each one the series of panels are disposed adjacent to preceding and succeeding panels in the series, while the first panel 100 in the series is disposed adjacent to a succeeding panel, and the last panel in the series is disposed adjacent to a preceding panel.

The plurality of panels are configured for co-operating with a wall 10 and a fastener configuration 400 for establishing the fastened panel assembly configuration 304, wherein, in the fastened panel assembly configuration 304, the assembled configuration 300 is secured to the wall 10 with the fastener configuration 400 such that the assembled configuration 300 covers at least a portion of a surface 12 of the wall 10. In some embodiments, for example, the plurality of panels are identical. In some embodiments, for example, the plurality of panels are different, but sufficiently similar such that all of the panels are configured to co-operate with each other in the same manner as the co-operation of the first and second panel 100, 200, as described herein.

In some embodiments, for example, the material of any one of the panels described herein includes plastic, for example, polyvinyl chloride (PVC), polypropylene, or recycled plastic. In some embodiments, for example, the material includes a composite material, such as, for example, wood fibre composite, recycled material, or cellular foam. In some embodiments, for example, the material includes aluminum. In some embodiments, for example, the material includes fibreglass.

In some embodiments, for example, any one of the panels described herein is manufactured by extrusion. In such embodiments, for example, any one of the panels described herein is an extruded lineal. In some embodiments, for example, any one of the panels described herein is manufactured by molding. In some embodiments, for example, any one of the panels described herein is manufactured by pultrusion.

In some embodiments, for example, the first panel 100 defines a first end 101, a second end 102 that is opposite the first end 101, a first side 103, and a second side 1031 disposed on an opposite side of the panel relative to the first side 103. In some embodiments, for example, the first and second sides 103, 1031 are connected by ribs 108. A front surface 104 is defined on the first side 103, and a rear surface 106 is defined on the second side 1031. The front surface 104 includes a recess 313. In some embodiments, for example, the panel 100 defines, at the first end 101, a first coupling configuration counterpart 310, and at the second end 102, a second coupling configuration counterpart 312. In some embodiments, for example, the first panel 100 also includes a fastener receiving portion 308.

In some embodiments, for example, the second panel 200 defines a first end 101, a second end 102 that is opposite the first end 101, a first side 103, and a second side 1031 disposed on an opposite side of the panel relative to the first side 103. A front surface 104 is defined on the first side 103, and a rear surface 106 is defined on the second side 1031. The front surface 104 includes a recess 313. In some embodiments, for example, the panel 100 defines, at the first end 101, a first coupling configuration counterpart 310, and at the second end 102, a second coupling configuration counterpart 312. In some embodiments, for example, the second panel 200 also includes a fastener receiving portion 308.

In some embodiments, for example, for each one of the first and second panels 100, 200, independently, the respective front surface 104 defines a visible surface 320 that is visible while the fastened panel assembly configuration 304 is established. In some embodiments, for example, for each one of the first and second panels 100, 200, independently, the respective visible surface 320 includes a respective planar surface 322 having a total surface area of at least three (3) inches squared, such as, for example, at least five (5) inches squared, such as, for example, at least ten (10) inches squared. In some embodiments, for example, for each one of the first and second panels 100, 200, independently, the respective front surface 104 includes a respective planar surface portion 322 that is oriented such that, while the fastened panel assembly configuration 304 is established, an axis that is normal to the respective planar surface portion 322, is disposed within five (5) degrees, relative to an axis that is normal to the wall surface 12. In some embodiments, for example, for each one of the first and second panels 100, 200, independently, while the panel 100 (200) is disposed in the fastened panel assembly configuration 304, the respective planar surface 322 is oriented in a parallel relationship with the wall surface 12, such that the axis, that is normal to the wall surface 12, is also normal to the planar surface 322.

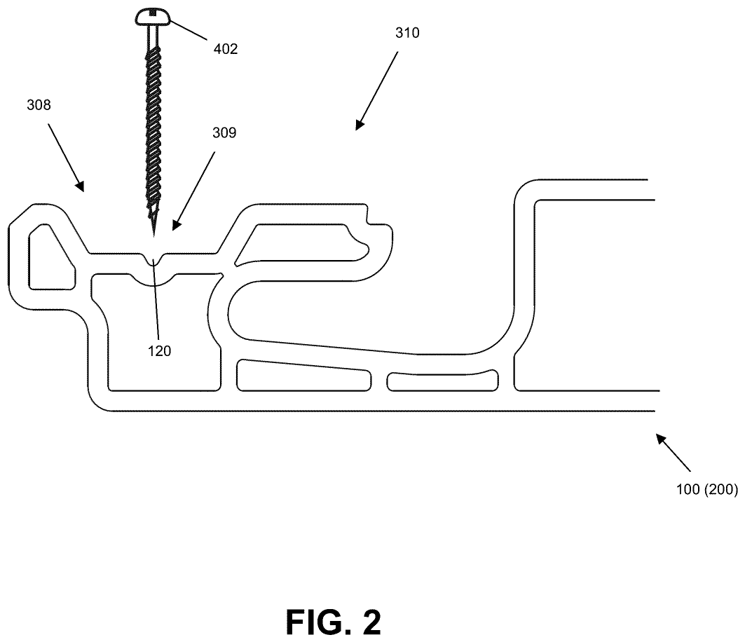

Referring to FIG. 2, in some embodiments, for example, for each one of the first and second panels 100, 200, independently, the respective fastener receiving portion 308 is configured for receiving one or more mechanical fasteners 402, for example, screws, bolts, pins, and the like, to connect the panel to a wall 10. In some embodiments, for example, for each one of the first and second panels 100, 200, independently, the respective fastener receiving portion 308 includes a respective fastener-engaging surface 309 that is configured to engage with a head of a fastener, and further configured to resist further displacement of the fastener through the respective panel 100 (200) while the fastener-engaging surface is engaged to the head of the fastener. In some embodiments, for example, for each one of the first and second panels 100, 200, independently, the connection of the respective panel 100 (200) to the wall 10 is effectuated by penetration of the respective fastener receiving portion 308 with the mechanical fastener such that the mechanical fastener extends through the respective fastener receiving portion 308 and into the wall 10, and the head of the mechanical fastener is bearing against the respective fastener-engaging surface, urging the panel 100 (200) into contact engagement with the wall 10.

In some embodiments, for example, for each one of the first and second panels 100, 200, independently, the respective fastener receiving portion 308 includes a respective fastener locator 120 for locating placement of a fastener in a fastener effective position, and for guiding the penetration of the respective panel 100 (200) by the mechanical fastener. In some embodiments, for example, for each one of the first and second panels 100, 200, independently, the respective fastener locator 120 includes a respective groove. In some embodiments, for example, for each one of the first and second panels 100, 200, independently, the respective fastener locator 120 is configured to receive the tip of a fastener 402. In some embodiments, for each one of the first and second panels 100, 200, independently example, the respective fastener locator is sufficiently deep and wide to receive the tip of the fastener. In some embodiments, for example, for each one of the first and second panels 100, 200, independently, the respective fastener locator is configured for co-operating with a tip of a fastener such that, while the tip of the fastener is received in the respective fastener locator, the position of the fastener receiving portion 308 is identified for a user to fasten the respective panel 100, 200 to a wall 10. In some embodiments, for example, for each one of the first and second panels 100, 200, independently, the respective fastener locator is configured for co-operating with a tip of the fastener such that, while the tip of the fastener is received in the respective fastener locator, the fastener is oriented such that the fastener is able to fasten the panel 100 (200) to a wall 10 in response to penetration of the respective fastener receiving portion 308. In some embodiments, for example, the groove is defined on the fastener-engaging surface.

“Fastener configuration 400” means one or more fasteners 402. In some embodiments, for example, the panel 100 is fastened to the wall 10 with four (4) fasteners, such that the fastener configuration 400, which effectuates fastening of a panel to the wall, is defined by four (4) fasteners. In some embodiments, for example, the fastened panel assembly configuration 304 is provided and includes ten (10) panels, and in some of these embodiments, for example, each one of the panels, independently, is fastened to the wall 10 with a respective four fasteners 402, such that there are 40 fasteners 402 which are fastening the ten (10) panels to the wall 10, such that the fastener configuration 400 is defined by 40 fasteners 402.

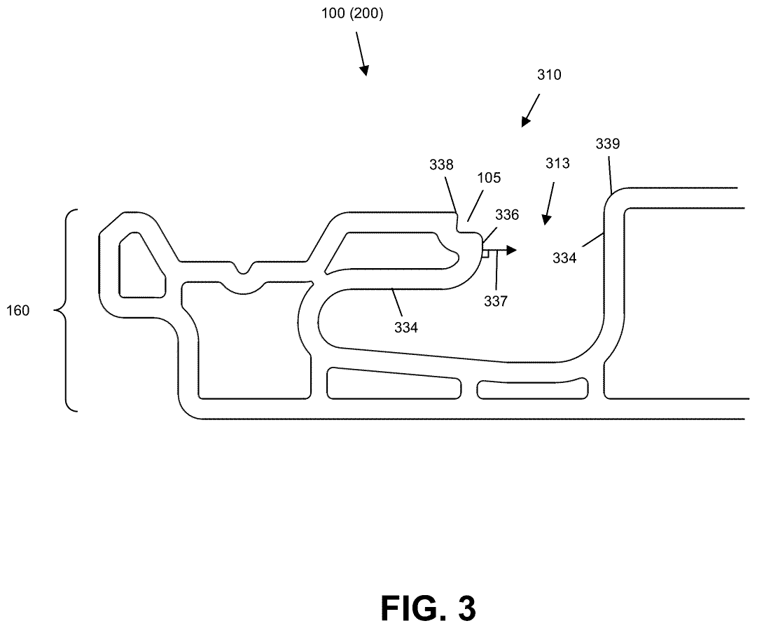

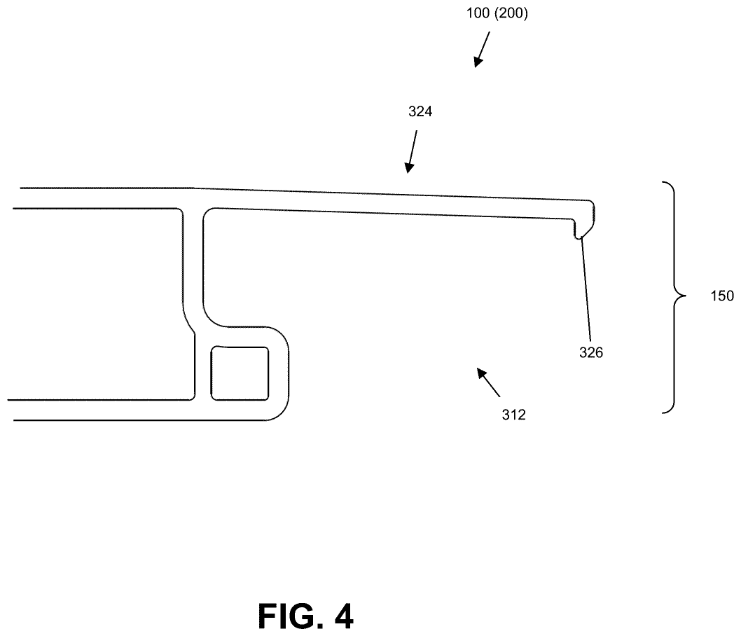

Referring to FIGS. 3 to 6, the first coupling configuration counterpart 310, that is respective to the first panel 100, is configured for coupling with the second coupling configuration counterpart 312, which is respective to the second panel 200, with effect that a first coupled configuration is established. The first coupling configuration counterpart 310, that is respective to the first panel 100, and the second coupling configuration counterpart 312, that is respective to the second panel 200, are co-operatively configured such that, while the first coupled configuration is established: (a) relative displacement between the first panel 100 and the second panel 200, along an axis that is: (i) parallel to the wall surface 12, and (ii) perpendicular to the longitudinal axis 100X (e.g. the axis of extrusion) of the first panel 100, is opposed (e.g. prevented); and (b) relative displacement between the first panel 100 and the second panel 200, along an axis 323 that is parallel to an axis that is normal to the wall surface 12 is opposed. In this respect, in some embodiments, while the first coupled configuration is established, pulling apart of the first and second panels 100, 200 is opposed. In some embodiments, for example, the first coupling configuration counterpart 310, that is respective to the first panel 100, includes the recess 313, and the second coupling configuration counterpart 312, that is respective to the second panel 200, includes a deflectable arm portion 324 with a terminal end defined by a rearwardly extending projection 326, and the first coupling configuration counterpart 310, that is respective to the first panel 100, and the second coupling configuration counterpart 312, that is respective to the second panel 200, are co-operatively configured such that, while the first coupled configuration is established, the rearwardly extending projection 326 is emplaced within the recess 313, with effect that the first and second panels 100, 200 become co-operatively disposed in a snap fit engagement. Simultaneously, while the rearwardly extending projection 326 is being emplaced within the recess 313, a nesting counterpart 160 of the first coupling configuration counterpart 310 that is respective to the first panel 100 becomes disposed in a nesting relationship with a nesting counterpart 150 of the second coupling configuration counterpart 312 that is respective to the second panel 200. In this respect, while: (i) the rearwardly extending projection 326, of the second panel 200, is emplaced within the recess 313 of the first panel, and (ii) a nesting counterpart 150 of the first panel 100 is disposed in a nesting relationship with a nesting counterpart 160 of the second panel 200, releasable locking of the second coupling configuration counterpart 312, that is respective to the second panel 200, to the first coupling configuration 310 that is respective to the first panel 100, is established. In some embodiments, for example, for transitioning between the unlocked state and the locked state, the arm portion 324 is deflected, with effect that at least one of the first and second panels 100, 200 can be pulled away from the other one of the first and second panels.

Also, and again with reference to FIGS. 3 to 6, the second coupling configuration counterpart 312, that is respective to the first panel 100, is configured for coupling with the first coupling configuration counterpart 310, that is respective to the second panel 200, with effect that a second coupled configuration is established. The second coupling configuration counterpart 312, that is respective to the first panel 100, and the first coupling configuration counterpart 310, that is respective to the second panel 200, are co-operatively configured such that: (a) relative displacement between the first panel 100 and the second panel 200, along an axis that is: (i) parallel to the wall surface 12, and (ii) perpendicular to the longitudinal axis 100X (e.g. axis of extrusion) of the first panel 100, is opposed; and (b) relative displacement between the first panel 100 and the second panel 200, along an axis 323 that is parallel to an axis that is normal to the wall surface 12 is opposed. In this respect, in some embodiments, while the second coupled configuration is established, pulling apart of the first and second panels 100, 200 is opposed. In some embodiments, for example, the first coupling configuration counterpart 310, that is respective to the second panel 200, includes the recess 313, and the second coupling configuration counterpart 312, that is respective to the first panel 100, includes a deflectable arm portion 324 with a terminal end defined by a rearwardly extending projection 326, and the first coupling configuration counterpart 310, that is respective to the second panel 200, and the second coupling configuration counterpart 312, that is respective to the first panel 100, are co-operatively configured such that, while the first coupled configuration is established, the rearwardly extending projection 326 is emplaced within the recess 313, with effect that the first and second panels become co-operatively disposed in a snap fit engagement. Simultaneously, while the rearwardly extending projection 326 is being emplaced within the recess 313, a nesting counterpart 160 of the first coupling configuration counterpart 310 that is respective to the second panel 200 becomes disposed in a nesting relationship with a nesting counterpart 150 of the second coupling configuration counterpart 312 that is respective to the first panel 100. In this respect, while: (i) the rearwardly extending projection 326, of the first panel 100, is emplaced within the recess 313 of the first panel, and (ii) a nesting counterpart 160 of the second panel 200 is disposed in a nesting relationship with a nesting counterpart 150 of the first panel 100, releasable locking of the second coupling configuration counterpart 312, that is respective to the first panel 100, to the first coupling configuration 310, that is respective to the second panel 200, is established. In some embodiments, for example, for transitioning between the unlocked state and the locked state, the arm portion 324 is deflected, with effect that at least one of the first and second panels 100, 200 can be pulled away from the other one of the first and second panels

Referring to FIG. 5, in some embodiments, for example, while the first coupled configuration is established, the rearwardly extending projection 326 of the second coupling configuration counterpart 312, that is respective to the second panel 200, is bearing against a notch 105 of the first coupling configuration counterpart 310 that is respective to the first panel 100. Also referring to FIG. 5, in some embodiments, for example, while the second coupled configuration is established, the rearwardly extending projection 326 of the second coupling configuration counterpart 312, that is respective to the first panel 100, is bearing against a notch 105 of the first coupling configuration counterpart 310 that is respective to the second panel 200.

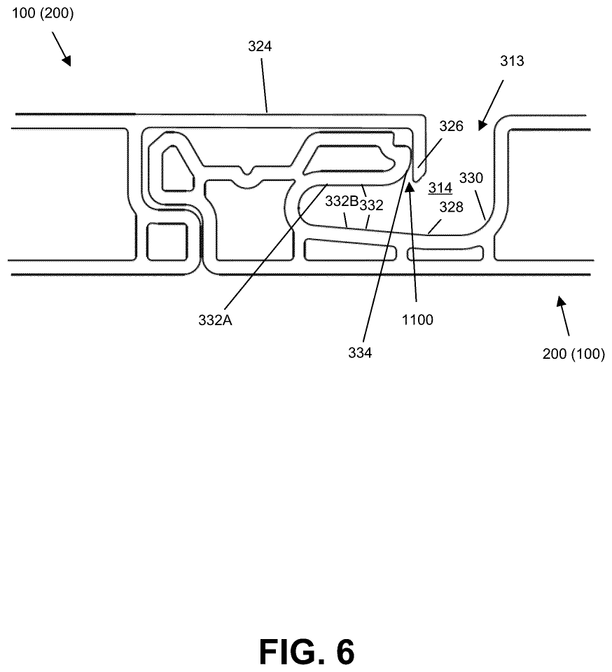

In some embodiments, for example, for each one of the first and second panels 100, 200, independently, a respective recess-defining surface 334 extends from respective spaced-apart upper and lower edges 338, 339 for defining the recess 313. The respective recess-defining surface 334 includes a respective upper surface portion 336, extending from the respective upper edge 338 to the respective retaining surface configuration 332, and oriented such that a respective axis 337, that is normal to the respective upper surface portion 336, is disposed, relative to the respective axis 323 that is normal to the respective planar surface portion 322, at an angle that is within a range, wherein the range is from 45 degrees to 135 degrees (such as, for example, from 60 degrees to 120 degrees, such as, for example, from 75 degrees to 105 degrees, such as, for example, 90 degrees). Referring to FIG. 6, in some embodiments, for example, the first and second panels 100, 200 are co-operatively configured such that, while the assembled configuration 300 is established, and the assembled configuration 300 is the first coupled configuration, the rearwardly-extending projection 326, that is respective to the first panel 100, extends into the recess 313 of the second panel 200 with effect that the upper surface portion 336, of the second panel 200, is concealed by the rearwardly-extending projection 326 of the first panel 100. Also referring to FIG. 6, in some embodiments, for example, the first and second panels 100, 200 are co-operatively configured such that, while the assembled configuration 300 is established, and the assembled configuration 300 is the second coupled configuration, the rearwardly-extending projection 326, that is respective to the second panel 200, extends into the recess 313 of the first panel 100 with effect that the upper surface portion 336, of the first panel 100, is concealed by the rearwardly-extending projection 326 that is respective to the second panel 200.

The establishing of either one of the first coupled configuration or the second coupled configuration establishes the assembled configuration 300.

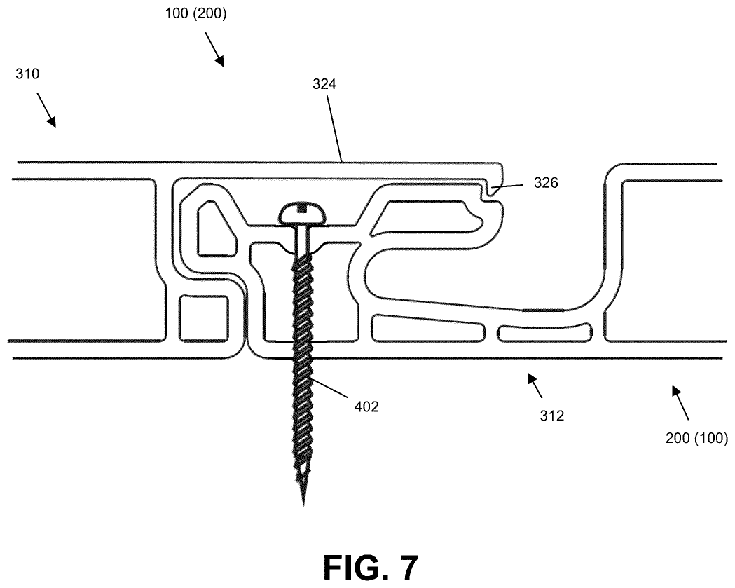

Referring to FIG. 7, in some embodiments, for example, while the first and second panels 100, 200 are disposed in the assembled configuration, the deflectable arm portion 324, that is respective to the first panel 100, is concealing the fastener receiving portion 308 (and the fastener 402) that is respective to the second panel 200. Similarly, in some embodiments, for example, while the first and second panels 100, 200 are disposed in the assembled configuration, the deflectable arm portion 324, that is respective to the second panel 200, is concealing the fastener receiving portion 308 (and the fastener 402) that is respective to the first panel 100

In some embodiments, for example, the first panel 100 is configured for co-operating with the second panel 200 such that, while the fastened panel assembly configuration 304 is established, at least a portion of the front surface 104 of the first panel 100 is co-planar with the front surface 104 of the second panel 200, and, in some of these embodiments, such relationship is intended to provide an aesthetically pleasing appearance.

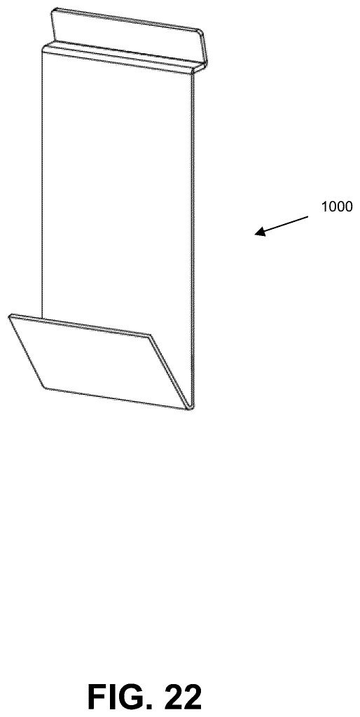

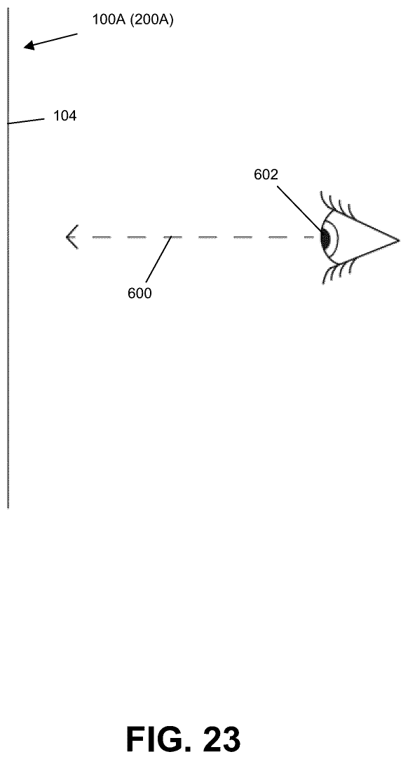

In some embodiments, for example, the first panel 100 is configured for co-operating with the second panel 200 such that, while the fastened panel assembly configuration 304 is established, a mounting bracket-receiving space 314 is established within the recess 313, that is respective to one of the first and second panels 100, 200, and which receives the second configuration counterpart 312 that is respective to the other one of the first and second panels 100, 200. The mounting bracket-receiving space 314 is configured for receiving emplacement of a mounting bracket 1000 (see FIG. 22) with effect that the mounting bracket becomes vertically supported within the space 314. In some embodiments, for example, the mounting bracket-receiving space 314 is defined by a receiving space-defining portion 328 that is respective to the one of the first and second panels 100, 200, within whose recess 313 is established the mounting bracket-receiving space 314.

In some embodiments, for example, the receiving space-defining portion 328 defines a guide surface 330 and a retaining surface configuration 332, and, in some of these embodiments, for example, the mounting bracket-receiving space 314, the guide surface 330, and the retaining surface configuration 332 are co-operatively configured such that, while the fastened panel assembly configuration 304 is established, and the mounting bracket is being inserted into the receiving space 314, the guide surface 330 engages the mounting bracket with effect that the mounting bracket 1000 is rotated, relative to the respective panel, such that movement of the mounting bracket 1000, within the receiving space 314, is directed, with effect that a retained configuration is established, wherein, in the retained configuration, the mounting bracket is vertically supported by the fastened panel assembly configuration 304, and the retaining surface configuration 332 is opposing displacement of the mounting bracket 1000, relative to the fastened panel assembly configuration 304, in both directions that are normal to the wall surface 12. In some embodiments, for example, the retaining surface configuration 332 including a forwardly-disposed retaining surface portion 332A and a rearwardly-disposed retaining surface portion 332B. The forwardly-disposed retaining surface portion 332A and the mounting bracket-receiving space 314 are co-operatively configured such that, while the mounting bracket is disposed within the mounting bracket-receiving space 314 such that the mounting bracket 1000 is supported by the fastened panel assembly configuration 304, displacement of the mounting bracket, relative to the fastened panel assembly configuration 304, in a forwardly direction that is normal to the wall 10, is opposed by the forwardly-disposed retaining surface portion 332A. The rearwardly-disposed retaining surface portion 332B and the mounting bracket-receiving space 314 are co-operatively configured such that, while the mounting bracket 1000 is disposed within the mounting bracket-receiving space 314 such that the mounting bracket 1000 is supported by the fastened panel assembly configuration 304, displacement of the mounting bracket 1000, relative to the fastened panel assembly configuration 304, in a rearwardly direction that is normal to the wall 10, is opposed by the rearwardly-disposed retaining surface portion 332B.

Referring to FIG. 12, to connect the panel 100 to a wall 10, the panel 100 is emplaced in abutting engagement against the wall 10. While disposed in abutting engagement with the wall 10, the fastener configuration 400 is emplaced, via corresponding fastener locators 120, in the fastening effective position, and is then forced to penetrate through the fastener receiving portion 308, and then the wall 10, such the panel 100 becomes disposed in a coupled relationship with the wall 10. While the panel 100 is disposed in a coupled relationship with the wall 10, the second panel 200 is then connected to the first panel 100, such as via snap-fit engagement.

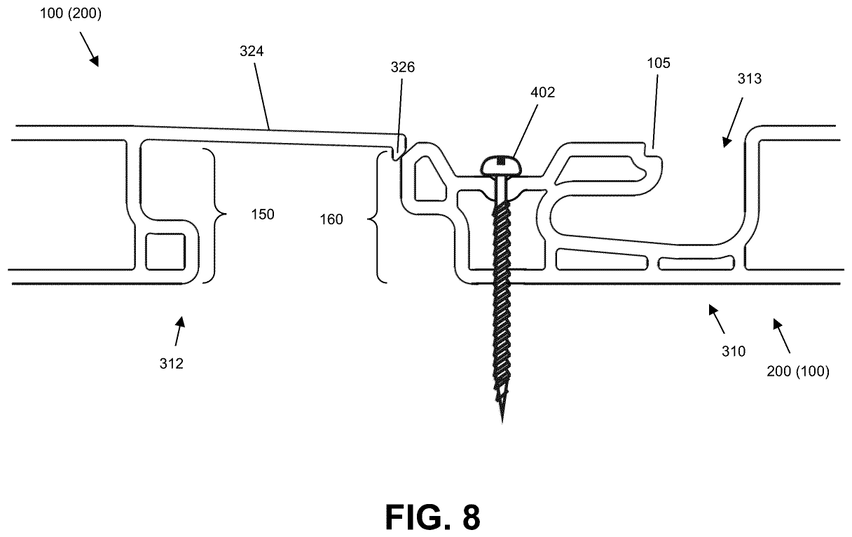

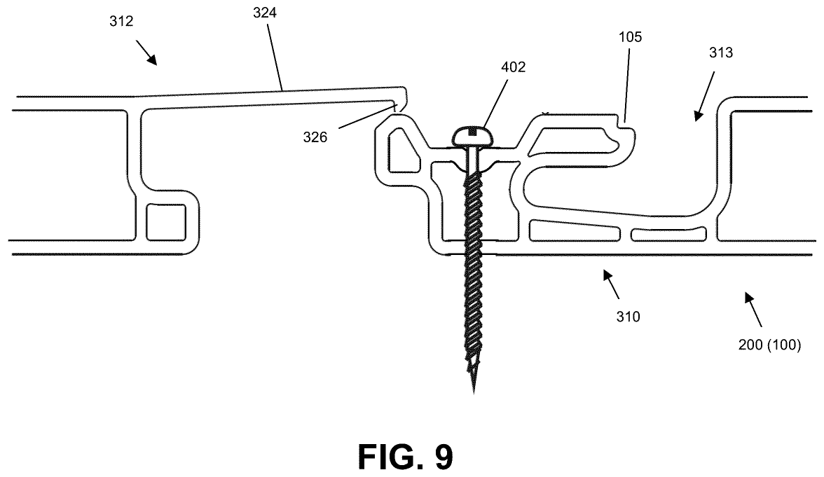

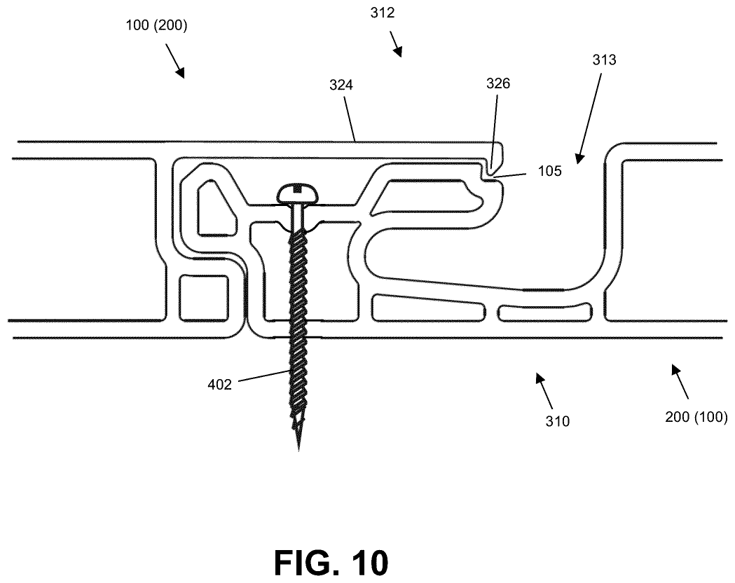

Referring to FIGS. 8 to 10, in some embodiments, for example, to couple the first panel 100 and the second panel 200, the first and second panels 100, 200 are emplaced in an end-to-end relationship, and the second panel 200 is displaced towards the first panel 100 with effect that the deflectable arm portion 324 is deflected (see FIG. 9) forwardly by the first coupling configuration counterpart 310 such that the arm portion 324 extends forwardly relative to the first panel 100. With further displacement of the second panel 200 towards the first panel 100, the rearwardly extending projection 326 becomes aligned with the recess 313, with effect that arm portion 324 is urged rearwardly, owing to the material bias, with effect that the rearwardly extending projection 326 becomes disposed within the recess 313. Simultaneously, while the rearwardly extending projection 326 is being emplaced within the recess 313, a nesting counterpart 160 of the first coupling configuration counterpart 310 that is respective to the first panel 100 becomes disposed in a nesting relationship with a nesting counterpart 150 of the second coupling configuration counterpart 312 that is respective to the second panel 200, with effect that the first and second panels 100, 200 become releasably locked. The second panel 200 is then coupled to the wall 10 with its own fastener configuration.

Additional like panels can be, successively, added to this assembly, in similar manner, such that the wall panel assembly, established by the connection of the panels, is defined by disposition of the panels in adjacent relationship to one another, for example, in a vertical series. In this respect, each one of the panels of wall panel assembly, independently, is elongated and is defined by a longitudinal axis, such that the disposition of the wall panels in adjacent relationship to one another, in a vertical series, is such that, for each one of the walls panels, independently, the longitudinal axis is horizontally oriented.

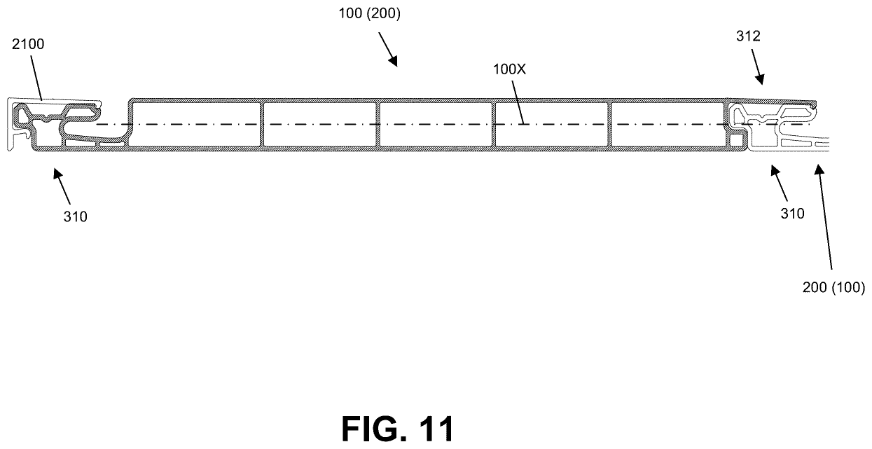

In some embodiments, for example, there is provided a kit for producing a fastened panel assembly configuration 304, and the kit includes a plurality of panels, and each one of the panels, independently, includes the features, described herein, for the first panel 100 (or, for that matter, the second panel 200), and are configured to co-operate with the other ones of the panels in the manner described herein. Referring to FIG. 11, in some embodiments, for example, the kit includes end trims components 2100 that are co-operatively connectible to the terminal panels 100 (200) in the series (via a similar connection as that for the panels 100 (200))

Referring to FIG. 12, in some embodiments, for example, the plurality of panels 100 (200) includes a plurality of image-establishing wall panels 100A (200A). For each one of the image establishing wall panels 100A (200a), independently, the image-establishing wall panel is identical to that of the wall panels 100 (200) described herein, with the exception that its front surface 104 defines a respective panel image. In this respect, each one of the image establishing wall panels 100A (200A), independently, includes a respective front surface 104 that defines a respective panel image 500.

In some embodiments, for example, for each one of the image-establishing wall panels 100A (200A), independently, the panel image 500 is defined on a plastic film (e.g. vinyl film, or cast film) which is applied, and adhered, to the panel 100A (200A).

In some embodiments, for example, for each one of the image-establishing wall panels 100a (200A), independently, the image-establishing wall panel 100A (200A) includes a composite material including a wall panel and an image-establishing material layer. The image-establishing material layer is adhered to the wall panel. In some embodiments, for example, the image-establishing material layer is adhered to a surface of the wall panel, such that the front surface is defined by the image-establishing layer. In some embodiments, for example, the image-establishing material layer includes a plastic film, and the plastic film defines the panel image. In such embodiments, for example, the panel image 500 is applied to the plastic film, and then the plastic film is applied to the surface of the wall panel, such as, for example, by adhering the plastic film to the surface of the wall panel. In some embodiments, for example, the plastic film is adhered to the wall panel with a suitable adhesive, and the adherence is effectuated by rollers or by hand. In some embodiments, for example, an overlaminate is applied over the adhered plastic film for protecting the plastic film from damage, such as, for example, damage from environmental elements.

A further example of a method of producing the image-establishing wall panel 100A (200A) will now be described. In some embodiments, for example, the panel image 500 is printed onto 3M™ IJ180CV3-10 or 3M™ IJ180MC-10 film via 3M™ qualified printers with Matched Component Systems (MCS™) ink, such that an image-establishing plastic film is defined, and then the image-establishing plastic film is applied to the front surface 104 of the panel 100 (200) by rollers or by hand, with effect that an intermediate panel is obtained. The image-establishing wall plastic film includes an adhesive, for example, a solvent acrylic adhesive, for adhering the image-establishing plastic film to the panel 100. In some embodiments, for example, the adhesive of the film is the 3M™ Comply™ v3 adhesive or the 3M™ Controltac™ adhesive. After the intermediate panel is formed, a 3M™ 8520 Matte overlaminate is applied over and adhered to plastic film (which has been adhered to the wall panel 100), with effect that the image-establishing wall panel 100A (200A) is obtained. In some embodiments, for example, the adhesive of the overlaminate, for adhering the overlaminate to the intermediate panel, is a clear adhesive. In some embodiments, for example, the overlaminate has a thickness of 2 millimeters.

In some embodiments, for example, the panel image 500 is applied directly to the panel 100A (200A), to obtain the image-establishing wall panel 100A (200A). In this respect, in some embodiments, for example, the panel image 500 is printed onto the front surface 104 of the panel 100A (200A), for example, via a printer, such as a graphic design printer.

In some embodiments, the provision of the plurality of image-establishing wall panels 100 (200) is with effect that there is provided a plurality of panel images 500.

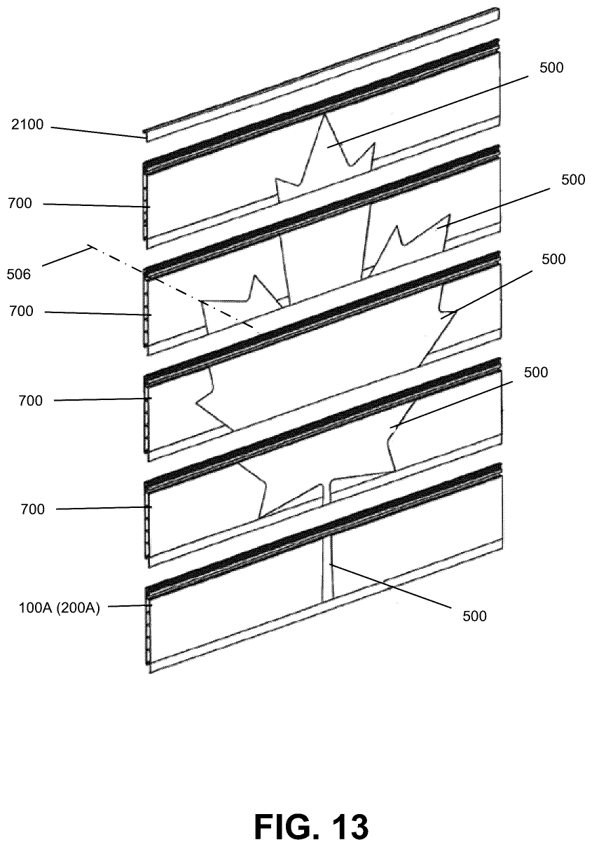

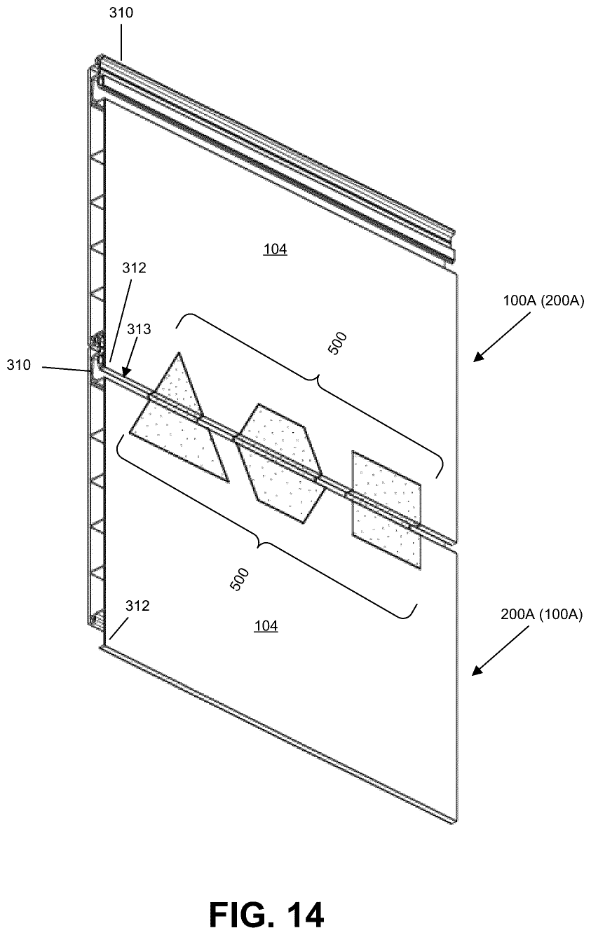

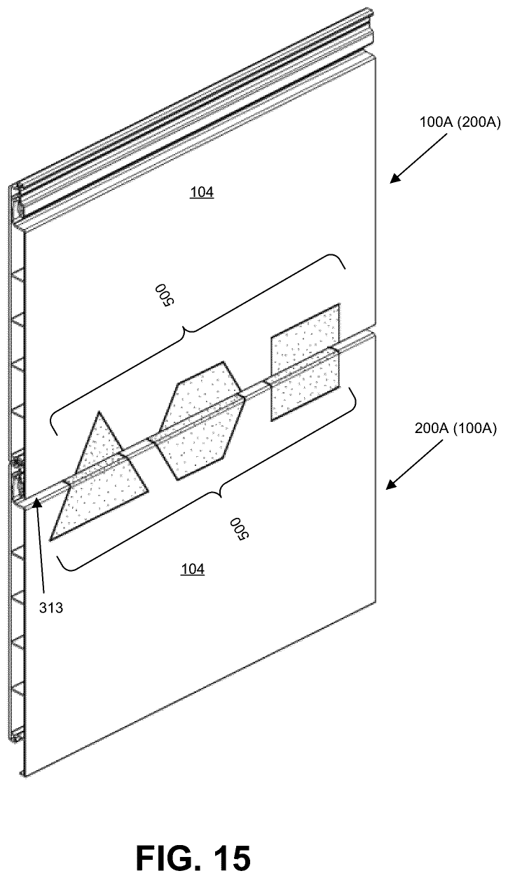

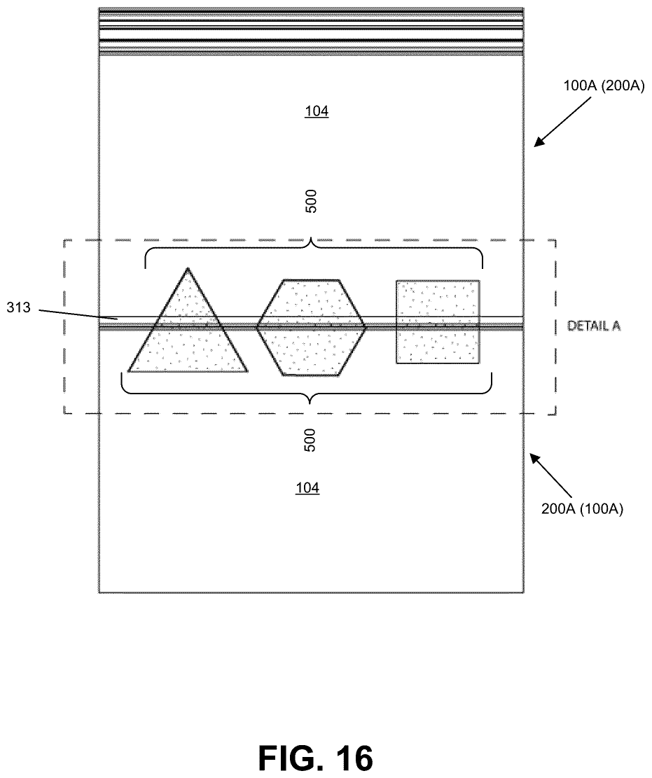

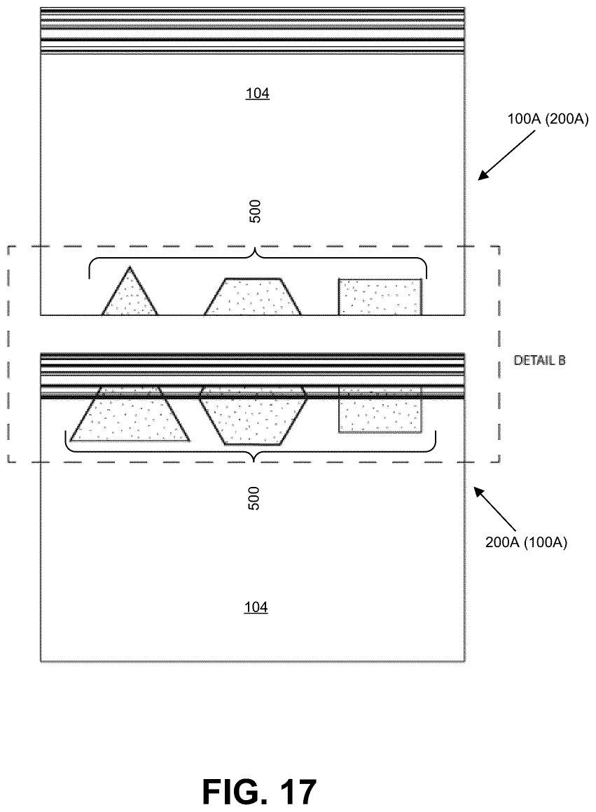

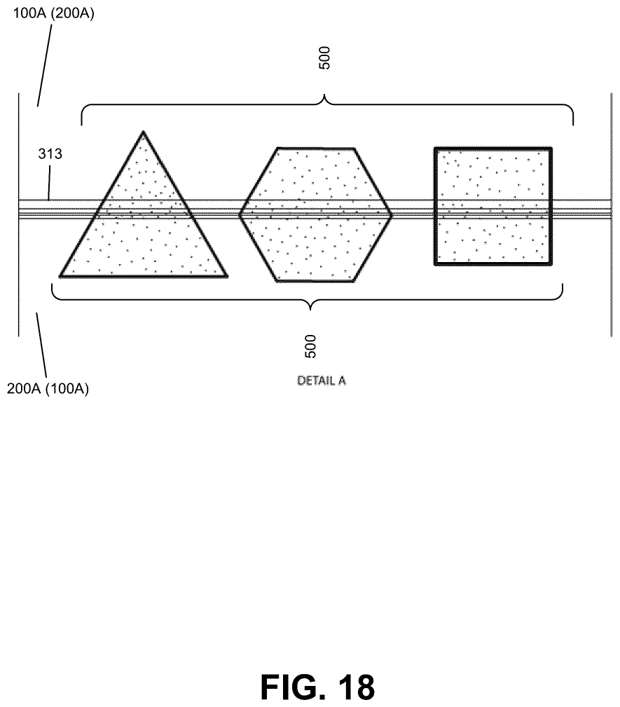

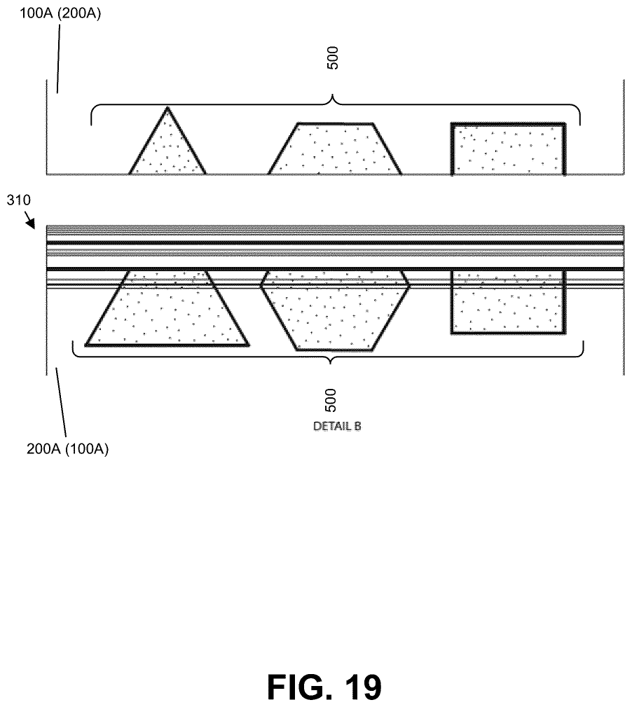

Referring to FIGS. 12 to 21, in some embodiments, for example, the image-establishing wall panels 100A (200A) are co-operatively configured for connection to establish a wall panel assembly (which includes the assembled configuration) which includes a completed image 502 that is defined by co-operation between the panel images 500 of the connected image-establishing wall panels 100A (200A).

In some embodiments, for example, there is an absence of a visually discernible discontinuity from a line of sight 600 extending from a point 602 facing the completed image (see FIG. 22).

In some embodiments, for example, the above-described connection is established at one or more joints 1100, and each one of the one or more joints, independently, is concealed from a line of sight 600 extending from a point 602, facing the completed image (see FIG. 22).

In some embodiments, for example, the completed image 502 is that of a completed object, and at least one of the image-establishing wall panels is a partial object image-defining panel 700. For each one of the at least one partial object-image defining panels 700, independently, the respective panel image 500 includes a visual representation of an incomplete object only.

For each one of the at least one partial object-image defining panels 700, independently, the respective panel image 500 includes a visual representation of an incomplete object only. In other words, for each one of the at least one partial object-image defining panels 700, independently, the panel 700, by itself, depicts, a visual representation of only a portion of an object.

For example, in some embodiments, the wall panel assembly 300 depicts the entirety of a hockey player (the “completed object”), including the face of the hockey player, and one portion of the face of hockey player is depicted on one of the panels 100A (200A), and the other portion of the face of the hockey player is depicted on another panel 100A (200A). In that case, each one of these panels (each of which, independently, depicts a portion of the face of the hockey player), independently, is a partial object-image defining panel 700, by virtue of the fact that a portion of the face of a hockey player is an “incomplete object only”. In contrast, for example, in some embodiments, the wall panel assembly 300 depicts a brick wall, and at least one of the panels 100A (200A) depicts the entirety of a brick only (i.e. the entirety of a brick, and nothing else), and the visual representation of the brick wall is obtained by connecting a plurality of panels. In that case, each one of the at least one panel 100A (200), that depicts the entirety of a brick, is not a partial object-image defining panels 700. This is because, despite depicting a portion of the brick wall, on its own, such panels depict the entirety of a brick, which is a “completed object”.

In some of these embodiments, for example, for each one of the at least one partial object-image defining panels 700, independently, the panel 700, by itself, can also depict other objects, with those other objects being depicted in their entirety. For example, in some embodiments, the wall panel assembly 300 depicts a hockey player with a helmet, and one of the panels 100A (200A) includes a depiction of a hockey helmet on a hockey player, and the entirety of the hockey helmet is depicted on such panel 100A (200A), but only a portion of the face of the hockey player is depicted on such panel 100A (200A). In that case, the panel 100A (200A), the image-establishing wall panel 100A (200A) is a partial object-image defining panel 700, by virtue of the fact that the panel depicts only a portion of the face of the hockey player (as a portion of the face of a hockey player is an “incomplete object only”).

The wall panels 700 are co-operatively configured for connection, to establish a wall panel assembly which includes a visual representation of a completed one of the incomplete object. In some embodiments, for example, the completed object is at least one of: a person, place, or thing. In some embodiments, for example, the completed object is a logo. In some embodiments, for example, the completed object is a machine. In some embodiments, for example, the completed object is an animal, such as, for example a human. In some embodiments, for example, the completed object is a human face.

In some embodiments, for example, the completed image 502 include an outline 504 extending across at least a pair of adjacent, connected panels 100 (200), and, for each one of the image-establishing wall panels 100A (200A), independently, a central axis 506 of the respective panel image 500 is offset relative to every central axis of the image-establishing wall panel 100A (200A). In some embodiments, for example, for each one of the image-establishing wall panels 100A (200A), independently, the central axis, of the image-establishing wall panel 100A (200A), relative to which the central axis 506 of the respective panel image 500 is offset, is parallel to the central axis 506 of the respective panel image 500. In some embodiments, for example, for each one of the image-establishing wall panels 100A (200A), independently, the central axis 506 of the respective panel image 500 is a central longitudinal axis. In some embodiments, for example, the completed object is at least one of: a person, place, or thing. In some embodiments, for example, the completed object is a logo.

In some embodiments, for example, the connection, to establish a wall panel assembly which includes a completed image 502, is a connection of the image-establishing wall panels 100A (200A) in a single order only. In some embodiments, for example, the order is a sequence.

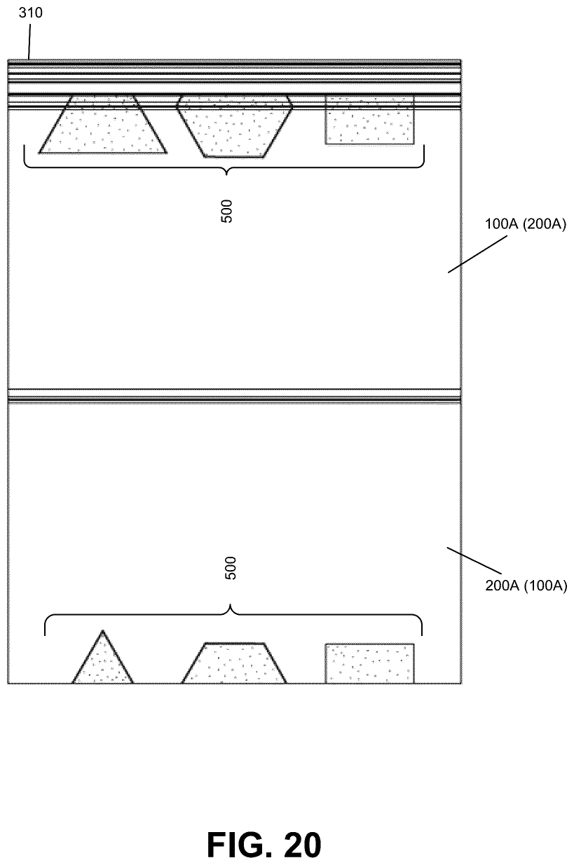

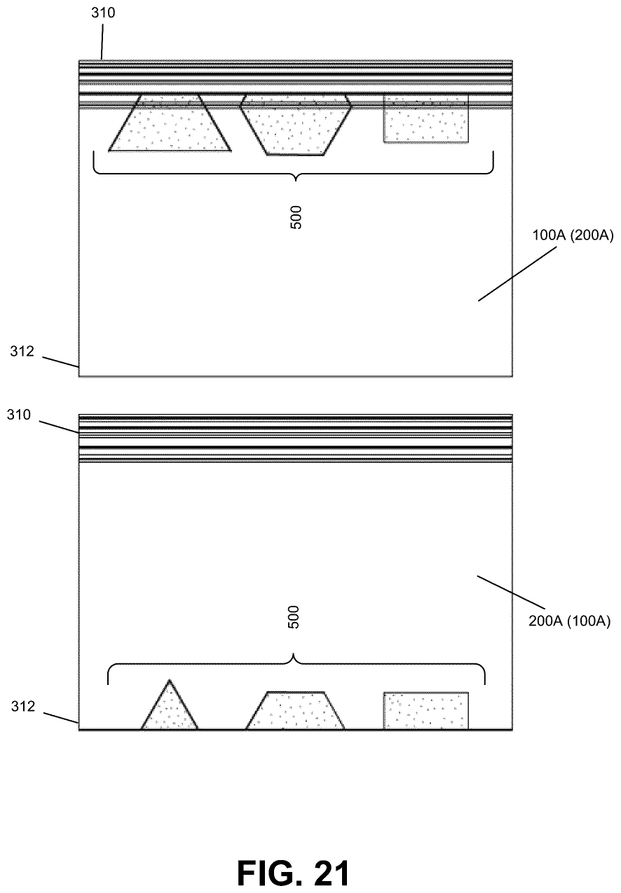

In some embodiments, for example, the image-establishing wall panels 100A (200A) are co-operatively configured for connection in a plurality of orders, and the plurality of orders includes:
an image-establishing order for establishing a wall panel assembly which includes a completed image 502 that is defined by co-operation between the panel images 500 of the connected image-establishing wall panels 100A (200A); and
an ineffective image-establishing order (see FIGS. 20 and 21) for establishing a wall panel assembly which includes a visual representation of other than the completed image.

In some embodiments, for example, the visual representation, of other than the completed image, is of a visually distorted version of the completed image 502.

In some embodiments, for example, for at least one of the image-establishing wall panels 100A (200A), independently, at least a portion of the respective panel image 500 is defined within the recess 313.

In some embodiments, for example, for at least one of the image-establishing wall panels 100A (200A), independently, at least a portion of the respective panel image 500 is defined by the concealing portion 340.

The preceding discussion provides many example embodiments. Although each embodiment represents a single combination of inventive elements, other examples may include all suitable combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations could be made herein.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

1. A kit for producing a wall panel assembly, wherein the kit comprises:
a plurality of image-establishing wall panels, each panel having a respective front surface and a respective panel image on at least a portion of the respective front surface; wherein
the respective front surface includes a respective recess for receiving a mounting bracket to be supported by the panel; and
at least a portion of the respective panel image is defined within the respective recess;
and
each panel is interconnectable with another panel of the plurality of panels to establish a wall panel assembly which includes a completed image, the completed image defined by co-operation between the panel images of adjacent panels of the wall panel assembly.

2. The kit as claimed in claim 1, wherein the respective recess of each panel extends longitudinally from a first end of the panel to a second, opposite end of the panel.

3. The kit as claimed in claim 1, wherein each respective panel further includes a first connection structure extending along a first edge of the panel and a second connection structure extending along a second edge of the panel opposite the first edge, wherein the second connection structure of a second panel is inter-engageable with the first connection structure of a first panel adjacent the second panel to interconnect the first and second panels.

4. The kit as claimed in claim 3, wherein the second connection structure of the second panel includes a cover member having a proximal end joined to the second panel proximate the front surface thereof and a distal end spaced apart from the proximal end, the cover member of the second connection structure covering the first connection structure of the first panel when interconnected therewith, and wherein the front surface of the panel includes a forward facing surface of the cover member.

5. The kit as claimed in claim 4, wherein the respective recess of each panel extends adjacent to, and inboard of, the first connection structure of the panel.

6. The kit as claimed in claim 5, wherein the first connection structure includes a notch in a forward facing surface of the first connection structure along an opening edge of the recess, and wherein the second connection structure includes a tab projecting rearwardly from the distal end of the cover member, the tab receivable in the notch in snap-fit when the first and second panels are interconnected.

7. The kit as claimed in claim 5, wherein the second connection structure includes a retainer projecting rearwardly from the distal end of the cover member, the retainer receivable in the recess adjacent an opening edge thereof when the first and second panels are interconnected.

8. The kit as claimed in claim 3, further comprising a plurality of fasteners, each fastener having a shank with a point at one end and a head at the opposite end, the fasteners insertable through a portion of the first connection structure of each panel to mount the panels to a wall.

9. The kit as claimed in claim 8, wherein the fasteners comprise screws.

10. A wall panel assembly, comprising:
a plurality of image-establishing wall panels, each panel having a respective front surface and a respective panel image on at least a portion of the respective front surface; wherein
the respective front surface includes a respective recess for receiving a mounting bracket to be supported by the panel; and
at least a portion of the respective panel image is defined within the respective recess; and wherein
the panels are assembled together by interconnection of each panel with an adjacent panel along respective longitudinal edges thereof, the assembled panels forming a completed image defined by co-operation between the panel images of the adjacent panels of the wall panel assembly.

11. The wall panel assembly of claim 10, wherein the respective recess of each panel extends longitudinally from a first end of the panel to a second end of the panel longitudinally opposite the first end.

12. The wall panel assembly of claim 10, wherein each respective panel further includes a first connection structure extending along a first longitudinal edge of said longitudinal edges of the panel and a second connection structure extending along a second longitudinal edge of said longitudinal edges of the panel opposite the first longitudinal edge, wherein the second connection structure of a second panel is inter-engageable with the first connection structure of a first panel adjacent the second panel to interconnect the first and second panels.

13. The wall panel assembly of claim 12, further comprising a plurality of fasteners for mounting the panels to a wall, each fastener passing through a portion of the first connection structure of the respective panel.

14. The wall panel assembly of claim 13, wherein the second connection structure of each panel includes a cover member having a proximal end joined to the respective panel proximate the front surface thereof and a distal end spaced apart from the proximal end, the cover member of the second connection structure covering the first connection structure of an adjacent panel interconnected therewith and covering the fasteners mounting the respective panel to the wall, and wherein the front surface of the panel includes a forward facing surface of the cover member.

15. The wall panel assembly of claim 14, wherein the respective recess of each panel extends adjacent to, and inboard of, the first connection structure of the panel.

16. The wall panel assembly of claim 15, wherein the first connection structure includes a notch in a forward facing surface of the first connection structure along an opening edge of the recess, and wherein the second connection structure includes a tab projecting rearwardly from the distal end of the cover member, the tab received in the notch in snap-fit when the adjacent panels are interconnected.

17. The wall panel assembly of claim 15, wherein the second connection structure includes a retainer projecting rearwardly from the distal end of the cover member, the retainer received in the recess adjacent an opening edge thereof when the adjacent panels are interconnected.

18. A panel which is configured to define a first panel for coupling to a second panel for establishing an assembled configuration, wherein the first panel is configured for co-operating with the second panel, a wall that defines a wall surface, and a fastener configuration for establishing a fastened panel assembly configuration, wherein, in the fastened panel assembly configuration, the assembled configuration is secured to the wall with the fastener configuration such that the assembled configuration covers at least a portion of a surface of the wall;
wherein:
the first panel includes a first coupling configuration counterpart;
the second panel includes:
a second coupling configuration counterpart;
a front surface, wherein the front surface includes a planar surface portion that is oriented such that, while the fastened panel assembly configuration is established, an axis, that is normal to the respective planar surface portion, is disposed within five (5) degrees, relative to an axis that is normal to the wall surface;
a recess extending from the planar surface portion;
a recess-defining surface, extending from spaced-apart upper and lower edges of the planar surface for defining the recess, and including:
a retaining surface configuration including a forwardly-disposed retaining surface portion and a rearwardly-disposed retaining surface portion;
wherein:
the forwardly-disposed retaining surface portion and the mounting bracket-receiving space are co-operatively configured such that, while a mounting bracket is disposed within the recess such that the mounting bracket is supported by the fastened panel assembly configuration, displacement of the mounting bracket, relative to the second panel, in a forwardly direction that is normal to the wall, is opposed by the forwardly-disposed retaining surface portion;
and
the rearwardly-disposed retaining surface portion and the recess are co-operatively configured such that, while a mounting bracket is disposed within the recess such that the mounting bracket is supported by the fastened panel assembly configuration, displacement of the mounting bracket, relative to the second panel, in a rearwardly direction that is normal to the wall, is opposed by the rearwardly-disposed retaining surface portion;
and
an upper surface portion, extending from the upper edge to the forwardly-disposed retaining surface portion, and oriented such that an axis, that is normal to the upper surface portion, is disposed, relative to the axis that is normal to the planar surface portion, at an angle that is within a range, wherein the range is from 45 degrees to 135 degrees;
the first coupling configuration counterpart, of the first panel, is configured for co-operation with the second coupling configuration counterpart, of the second panel, such that, in the assembled configuration, the first coupling configuration counterpart, of the first panel, is coupled to the second coupling configuration counterpart, of the second panel;
and
the first panel is configured for co-operation with the second panel such that, while the assembled configuration is established, the first coupling configuration counterpart, of the first panel, extends into the recess, of the second panel, with effect that the upper surface portion, of the second panel, is concealed by a concealing portion of the first coupling configuration counterpart, of the first panel.

19. The panel as claimed in claim 18;
wherein:
the front surface defines a panel image; and
at least a portion of the panel image is displayed on the concealing portion.
